(19) United States
(12) Patent Application Publication
(10) Pub. No.: US 2023/0316291 A1
(43) Pub. Date: Oct. 5, 2023

(54) PHYSICAL MEDIUM FOR RESTRICTED ACCOUNT ACCESS TO CONTRIBUTED RESOURCES

(71) Applicant: Capital One Services, LLC, McLean, VA (US)

(72) Inventors: Maneill PAREKH, Washington, DC (US); Erik NEIGHBOUR, Arlington, VA (US)

(21) Appl. No.: 17/657,971

(22) Filed: Apr. 5, 2022

(51) Int. Cl. G06Q 20/40; G06Q 20/34

(52) U.S. Cl. CPC G06Q 20/409; G06Q 20/341

(57) ABSTRACT

In some implementations, a physical medium may include a radio frequency (RF) component, an integrated circuit (IC) chip component, a memory, and one or more processors coupled to the memory. The physical medium may be configured to provide an indication of an identifier of an account associated with the physical medium via the RF component, the IC chip component, or an optical image displayed on a surface of the physical medium. The physical medium may be configured to transmit an indication of the identifier to initiate a first exchange associated with receiving resources from another account. The physical medium may be configured to communicate with a terminal, based on detecting that the physical medium is within a communicative proximity of the terminal, to complete a second exchange at least partially using the resources based on information associated with the second exchange satisfying one or more restriction parameters.

### BACKGROUND

A physical medium may be used to access resources of an account. The physical medium may include a radio frequency (RF) component for communicating with other physical mediums or other devices. The physical medium may include an integrated circuit (IC) chip component to improve security with respect to the use of the physical medium.

### SUMMARY

Some implementations described herein relate to a physical medium for restricted account access. The physical medium may include a radio frequency (RF) component and an integrated circuit (IC) chip component. The physical medium may include a memory and one or more processors coupled to the memory. The one or more processors may be configured to provide an indication of an identifier of an account associated with the physical medium, wherein the indication of the identifier is provided via the RF component, the IC chip component, or an optical image displayed on a surface of the physical medium. The one or more processors may be configured to transmit, to a device and via the RF component, an indication of the identifier to initiate a first exchange associated with receiving resources to the account from another account associated with a user of the device, wherein the resources are associated with one or more restriction parameters. The one or more processors may be configured to detect, via the RF component or the IC chip component, that the physical medium is within a communicative proximity of a terminal. The one or more processors may be configured to communicate, via the RF component and with the terminal, to complete a second exchange at least partially using the resources based on information associated with the second exchange satisfying the one or more restriction parameters.

Some implementations described herein relate to a system for restricted account access to contributed resources. The system may include one or more memories and one or more processors coupled to the one or more memories. The one or more processors may be configured to generate an identifier associated with an account that is associated with a physical medium, wherein the account is not associated with any personally identifiable information of a particular user. The one or more processors may be configured to receive an indication of a first exchange associated with contributing resources from another account to the account. The one or more processors may be configured to configure the resources to be available for the account with one or more restrictions on a use of the resources. The one or more processors may be configured to receive an indication of a second exchange that is initiated by the physical medium that is to be at least partially completed using the resources, wherein the indication includes information associated with the second exchange. The one or more processors may be configured to transmit an indication of whether the second exchange is approved based on a determination of whether the information associated with the second exchange complies with the one or more restrictions.

Some implementations described herein relate to a method for providing a physical medium for restricted account access. The method may include establishing, by a device, an account that is associated with a physical medium, wherein the account is associated with an identifier that provides routing information associated with contributing resources to the account. The method may include receiving, by the device, an indication of a first exchange associated with contributing resources from another account to the account. The method may include configuring, by the device, the resources to be available for the account in accordance with one or more restrictions on a use of the resources. The method may include receiving, by the device, an indication of a second exchange that is initiated by the physical medium that is to be at least partially completed using the resources, wherein the indication includes information associated with the second exchange. The method may include transmitting, by the device, an indication of whether the second exchange is approved based on a determination of whether the information associated with the second exchange complies with the one or more restrictions.

### BRIEF DESCRIPTION OF THE DRAWINGS

FIGS. 1A-1D are diagrams of an example implementation relating to a physical medium for restricted account access to contributed resources.

FIG. 2 is a diagram of an example environment in which systems and/or methods described herein may be implemented.

FIG. 3 is a diagram of example components of one or more devices of FIG. 2.

FIGS. 4 and 5 are flowcharts of example processes relating to a physical medium for restricted account access to contributed resources.

### DETAILED DESCRIPTION

The following detailed description of example implementations refers to the accompanying drawings. The same reference numbers in different drawings may identify the same or similar elements.

In some cases, a payment medium (e.g., a transaction card, a transaction device, and/or a payment application, among other examples) may be associated with an account. Typically, the account is associated with a particular user. For example, the user may sign up for, or apply for, the account with an institution. The institution may approve the application of the user, generate the account, and/or provide the payment medium to the user to enable the user to complete transactions using the payment medium and resources associated with the account. However, in some cases, an account may not be associated with any particular user. For example, the payment medium may be a pre-paid card, a gift card, a gift certificate, a cash card, a pre-paid stored value card, a gift voucher, and/or another medium associated with storing resources associated with the medium and the account while not being associated with any particular user. Often, such payment mediums may be used to complete transactions until the pre-paid resources associated with the account are exhausted. After the resources associated with the account are exhausted, the payment medium may be discarded. This process is inefficient and creates waste associated with physical mediums (e.g., the payment mediums) that are discarded after the pre-paid resources associated with the payment mediums and/or accounts are exhausted.

In some cases, one or more users may wish to contribute resources to the account (e.g., that is not associated with any particular user) associated with the payment medium from time to time. For example, to contribute resources to the account, a user may be required to navigate, via a user device or a client device, to a web page or other interface associated with the account of the payment medium or with an account of the user, input identifier information associated with the account and/or the account of the user, and/or input information related to a quantity of resources to be contributed, among other examples. The user device or the client device may receive the request from the user, process the request, communicate with one or more backend servers to complete the request to cause the resources to be contributed to the account associated with the user, and/or cause a notification to be displayed to the user indicating whether the request was completed successfully, among other examples. This consumes significant computing resources, processing resources, network resources, and/or power resources (e.g., battery resources of devices), among other examples, associated with enabling the user to contribute resources to the account associated with the payment medium.

In some examples, the user may use a payment application (e.g., a peer-to-peer payment application) to contribute the resources to the account. However, the payment application may require that the user who is in possession of the payment medium have a device with the payment application installed thereon in order to enable the contribution of resources to the account to be completed. In some cases, the user who is in possession of the payment medium may not possess a device capable of executing the payment application, may not have an account with the payment application, and/or may other be unable to perform one or more steps associated with enabling the resources to be contributed to the account via the payment application. As a result, the user may not be able to use the payment application to contribute resources to the account. Therefore, the user may be required to perform steps that consume additional computing resources, processing resources, network resources, and/or power resources (e.g., battery resources of devices), among other examples (e.g., as described above). Additionally, or alternatively, the user may be required to perform steps to contribute the resources to the account using techniques that include additional devices or components (e.g., via a card reader or terminal), thereby increasing a complexity associated with the contribution and/or requiring the additional devices or components to be present when the contribution takes place.

Additionally, in some cases, a contribution of resources to the account (e.g., that is not associated with any particular user) may be associated with one or more restrictions. For example, the user contributing the resources may request that the resources be used for a particular purpose, for transactions with one or more particular entities, and/or other restrictions. However, an institution that manages the account (e.g., that is not associated with any particular user) may not be associated with means to restrict exchanges or transactions associated with the payment medium (e.g., because the account is not associated with any particular user, the institution may not associate any restrictions with a use of the resources of the account). Moreover, because the restrictions may be dynamic (e.g., may change over time), the institution that manages the account may be unable to change or modify any restrictions on a use of the resources associated with the account. As a result, unauthorized transactions may be completed via the payment medium, thereby consuming computing resources, processing resources, network resources, and/or power resources, among other examples, associated with identifying the unauthorized transactions and/or remedying the unauthorized transactions.

Some techniques and implementations described herein enable a physical medium for restricted account access to contributed resources. For example, the physical medium may be capable of accepting and/or receiving contributions of resources to an account associated with the physical medium. For example, the physical medium may provide an indication of an identifier of an account associated with the physical medium, via a radio frequency (RF) component, an integrated circuit (IC) chip component, and/or an optical image displayed on a surface of the physical medium. The identifier may indicate routing information associated with the account. The routing information may indicate an address and/or an identifier to be associated with communications to complete a contribution of resources to the account associated with the physical medium, thereby enabling a backend device or a payment application to complete the contribution without requiring a user to navigate through multiple web pages or interfaces or perform additional processing steps.

Additionally, the physical medium may be capable of initiating and/or completing transactions using the contributed resources associated with the account. In some implementations, a backend device associated with the account may associate resources of the account with one or more restrictions (e.g., with one or more restriction parameters). For example, the backend device may configure the resources to be available for the account with one or more restrictions on a use of the resources. The one or more restrictions may include one or more permitted or restricted entity categories, one or more permitted or restricted entities, one or more permitted or restricted items, one or more permitted or restrict item categories, one or more permitted or restricted exchange types, a time restriction, and/or a geographic restriction, among other examples. The backend device may receive an indication of a transaction that is initiated by the physical medium that is to be at least partially completed using the resources contributed to the account. The backend device may transmit an indication of whether the transaction is approved based on a determination of whether information associated with the transaction complies with the one or more restrictions, as described in more detail elsewhere herein.

As a result, the physical medium described herein enables a process associated with contributing resources to an account associated with the physical medium to conserve computing resources, processing resources, network resources, and/or power resources (e.g., battery resources of devices), among other examples, that would have otherwise been used to contribute resources to the account. Additionally, the physical medium described herein enables resources to be contributed to the account without requiring additional devices or components (e.g., a card reader and/or a terminal) and/or without requiring a user to navigate through multiple web pages and/or applications to complete a contribution of resources to the account associated with the physical medium. This may improve an efficiency of a use of the physical medium (e.g., that is not associated with any particular user) because the physical medium may be used over time (e.g., even after resources that are pre-paid or pre-loaded into the account are exhausted) by enabling resources to be efficiently contributed to the account associated with the physical medium. Therefore, the physical medium (e.g., the payment medium) described herein may enable a holistic and efficient process for accepting contributed resources to an account and for initiating transactions associated with the contributed resources from the same physical medium.

Additionally, the restrictions that are associated with the contributed resources may reduce a likelihood of unauthorized transactions that are initiated via the physical medium. For example, the restrictions that are associated with the contributed resources may ensure that the resources are used for transactions that comply with an intended use of the contributed resources. This may conserve computing resources, processing resources, network resources, and/or power resources, among other examples, that would have otherwise been used associated with identifying the unauthorized transactions and/or remedying the unauthorized transactions.

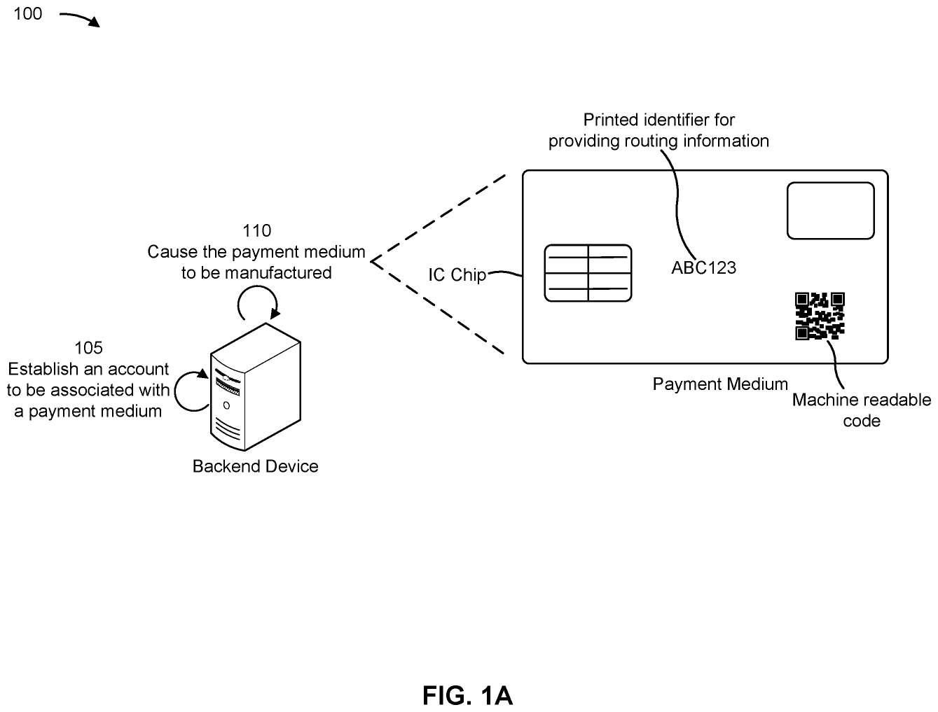

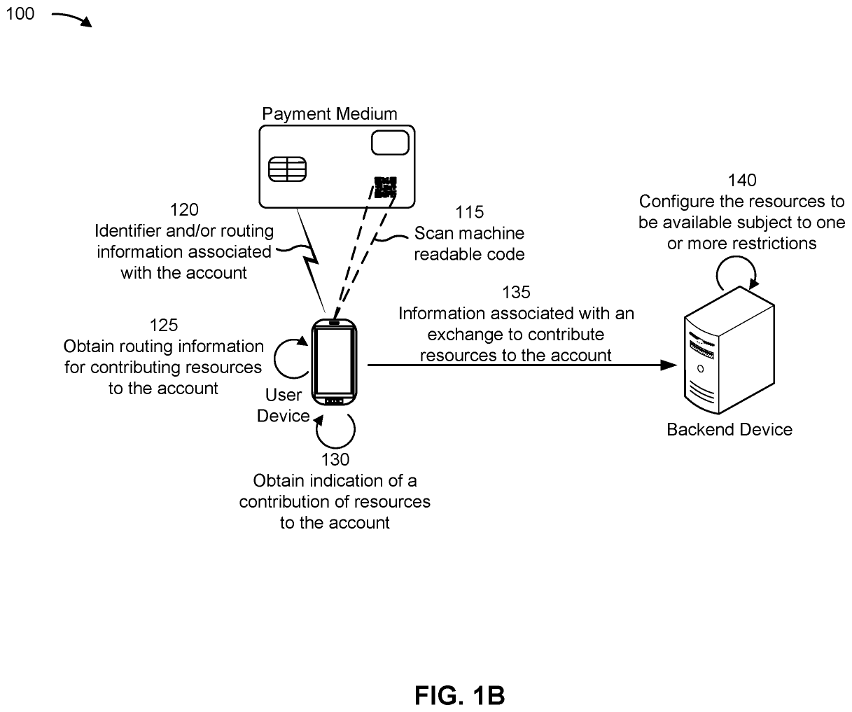

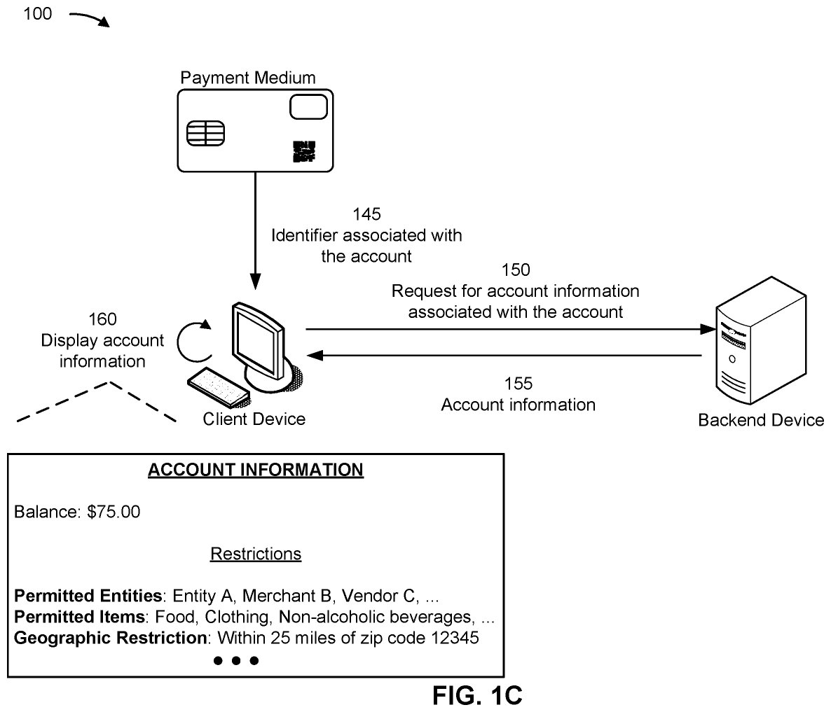

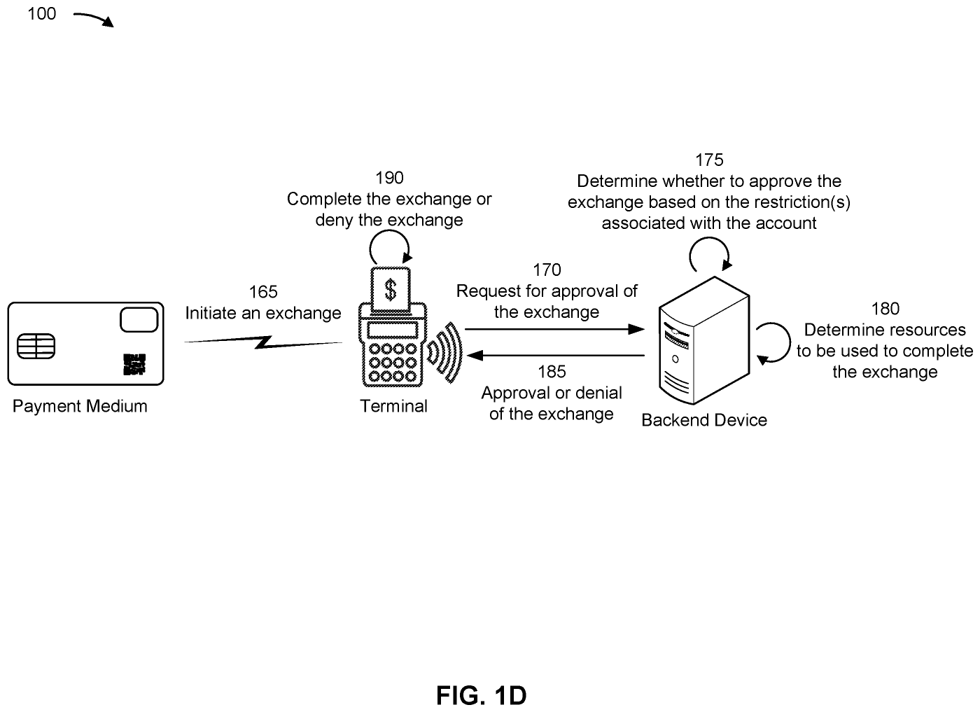

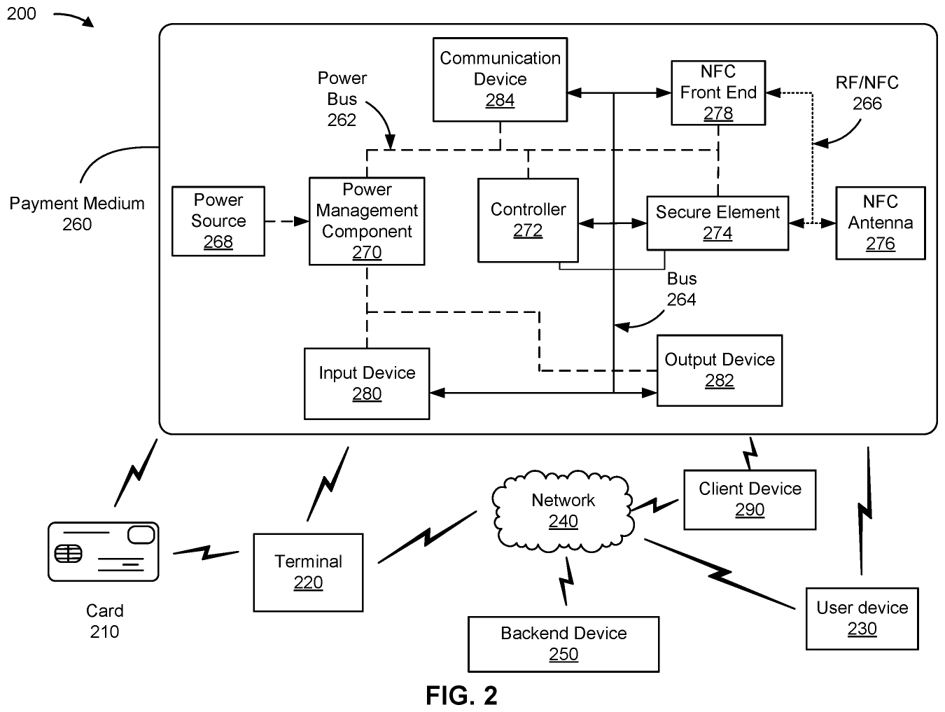

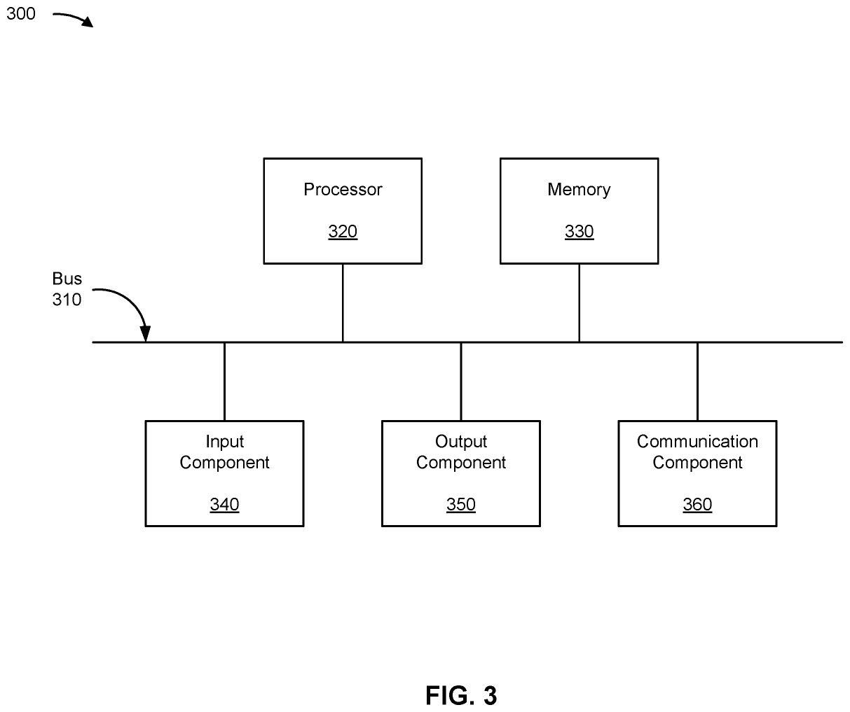

FIGS. 1A-1D are diagrams of an example 100 associated with a physical medium for restricted account access to contributed resources. As shown in FIGS. 1A-1D, example 100 includes a backend device, a payment medium, a user device, a client device, and a terminal. These devices are described in more detail in connection with FIGS. 2 and 3.

As shown in FIG. 1A, and by reference number 105, the backend device may establish an account to be associated with the payment medium. The account may not be associated with a particular user. For example, the payment medium may be associated with the account, but may not be tied to a user. In this way, the payment medium may be used by multiple users and/or be transferred from one user to another without requiring information stored by the backend device to be modified or changed. In other words, where the account is not associated with any personally identifiable information (PII) (e.g., a name, an address, a social security number, or other information) of a particular user. In this way, the account and/or the payment medium may provide a flexible payment medium for accepting and using contributed (e.g., donated) resources, as described in more detail elsewhere herein.

In some implementations, the backend device may generate an identifier associated with the account that is associated with a physical medium. The identifier may indicate routing information associated with contributing resources to the account. In some examples, the identifier may be an identifier associated with a payment application, such as a peer-to-peer payment application. For example, the identifier may be used by the payment application to identify the account. For example, the backend device may communicate with one or more other devices (e.g., associated with one or more payment applications) to generate one or more identifiers that can be used by the one or more payment applications to identify the account.

In some implementations, the backend device, when establishing the account, may be associated with account with one or more restrictions on a use of resources associated with the account. As used herein, “resources” may refer to any resources that may be used to complete a transaction or an exchange. For example, the resources may include currency, virtual currency, cryptocurrency, and/or other resources. As used herein, “exchange” may refer to a transaction, an electronic exchange, a sale, a payment, and/or a transfer, among other examples. For example, “exchange” and “transaction” may be used interchangeably herein. As used herein, “exchange medium” and/or “payment medium” may refer to a transaction device, a physical medium, a payment device, a transaction card, a credit card, a debit card, a payment application executing on a user device, and/or a digital wallet associated with a user device, among other examples. For example, the payment medium may include a card (e.g., a physical card), a user device (e.g., executing a payment application), and/or a wearable device (e.g., a smart wearable device, such as a smart watch, smart jewelry, and/or smart eyeglasses, among other examples), among other examples.

If the resources include cryptocurrency, the one or more restrictions may be included in, or indicated by, one or more blocks of a blockchain or another distributed ledger associated with the cryptocurrency. For example, the one or more restrictions may be associated with a smart contract in the blockchain or distributed ledger. For example, the distributed ledger may be immutable, such that no user or entity can edit, revise, and/or update an entry in the distributed ledger. The distributed ledger may be a blockchain. In such cases, a smart contract may be implemented via multiple blocks linked together in the blockchain. For example, a new block may be added to the blockchain for a smart contract when a restriction, associated with the smart contract, is added or updated. In this way, smart contracts (and/or corresponding contracts) can be secured in the distributed ledger while providing transparency of a history of the contract. In such examples, the backend device may enforce the one or more restrictions, as described in more detail elsewhere herein, in accordance with the smart contract. In other examples, the backend device may store an indication of the one or more restrictions as being associated with the account (e.g., associated with account information and/or an account configuration).

In some implementations, the one or more restrictions may apply to all resources associated with the account. For example, any transaction initiated by the payment medium may be required to comply with the one or more restrictions, as described in more detail elsewhere herein. Additionally, or alternatively, the one or more restrictions may be associated with particular resources that were contributed from a given account. For example, when contributing resources to the account, a user may specify or indicate one or more restrictions to be associated with the contributed resources, as described in more detail elsewhere herein. The backend device may store the one or more restrictions as being associated with the resources contributed by the user. Therefore, in some cases, the one or more restrictions may include a first one or more restrictions associated with all resources associated with the account and a second one or more restrictions associated with resources contributed from a particular other account.

The one or more restrictions may include one or more permitted or restricted entity or vendor categories (e.g., grocery stores, clothing stores, and/or restaurants, among other examples), one or more permitted or restricted entities (e.g., particular vendors or vendor identifiers), one or more permitted or restricted items, one or more permitted or restricted item categories (e.g., food, non-alcoholic beverages, clothing, and/or shelter, among other examples), one or more permitted or restricted exchange types (e.g., in-person transactions, online transactions, and/or card-not-present transactions), a time restriction (e.g., indicating an amount of time during which the resources must be used), and/or a geographic restriction (e.g., indicating a geographic area in which the resources are permitted to be used), among other examples. For example, the one or more restrictions may be indicated, or stored, by the backend device via one or more restriction parameters. For example, the one or more restriction parameters may include a permitted or restricted entity category restriction parameter, a permitted or restricted entity parameter, a permitted or restricted item parameter, an exchange type parameter, a time restriction parameter, and/or a geographic restriction parameter, among other examples.

For example, the one or more restrictions may indicate that the resources of the account can be used to complete transactions at grocery stores, restaurants, hotels, and/or clothing stores, but not at a liquor store, among other examples. As another example, the one or more restrictions may indicate that the resources of the account can be used to complete transactions for food, clothing, and/or shelter services (e.g., a hotel room), but cannot be used to complete transactions for alcoholic beverages, entertainment items or service, or be withdrawn for cash. In some implementations, the one or more restrictions may indicate that the resources of the account can only be used to complete transactions associated with certain vendors, certain items and/or certain services (e.g., and cannot be used to complete transactions associated with any other venders, items, and/or services).

In some implementations, the one or more restrictions may indicate that the physical medium is to be used to complete exchanges that comply with parameters associated with an assistance program that is defined by a regulatory agency. For example, the assistance program may be a supplemental nutrition assistance program (e.g., a food stamps program) or another assistance program associated with aiding low-income individuals. This type of restriction may reduce a complexity associated with restricting access to the contributed resources of the account because the backend device and/or other devices associated with completing transactions may already be configured to determine whether entities, vendors, merchants, items, and/or services comply with the parameters associated with the assistance program. Therefore, new restrictions and/or configurations may not be needed to determine whether a given transaction complies with this type of restriction.

The one or more restrictions may facilitate a contribution of resources to the account. For example, a user may be more inclined to contribute resources to the account knowing that the one or more restrictions are in place to restrict a use of the contributed resources. For example, the payment medium may be in the possession of a low-income or homeless individual. A user may be more inclined to contribute (e.g., donate) resources to the individual (e.g., via the payment medium as described in more detail elsewhere herein) because the one or more restrictions may limit a use of the contributed resources (e.g., and the user may know that the contributed resources will be used for a particular purpose and not wasted). As another example, the payment medium may be in the possession of a child or another individual. A user may be more inclined to contribute resources to the account knowing that the child or other individual can only use the resources to complete transactions for specific purposes (e.g., as indicated by the one or more restrictions). The one or more restrictions, in combination with the improved efficiency of contributing the resources via the payment medium, as described in more detail elsewhere herein, may increase a likelihood that users contribute or donate resources to the account associated with the payment medium.

As shown by reference number 110, the backend device may cause the payment medium (e.g., a physical medium) to be manufactured. As shown in FIG. 1A as an example, the payment medium may be a card. The card may include an IC chip, an RF component, a magnetic stripe, and/or other components (e.g., such as the components described in connection with FIG. 2) to facilitate the initiation of transactions. In some implementations, the payment medium may be manufactured with an indication of the identifier associated with the account printed on a surface of the physical medium. For example, the indication may include a machine readable code, an optical image, a Quick Response (QR) code, and/or one or more characters associated with the identifier (e.g., the printed identifier of ABC123 as shown in FIG. 1A), among other examples. In some implementations, the payment medium may be configured to display (e.g., via an output device, screen, or other display device) the indication. Additionally, or alternatively, the indication may be printed on the surface of the payment medium. As described above, the identifier associated with the account may provide routing information associated with the account to enable a payment application to complete a transaction to contribute resources to the account from another account.

In some implementations, the physical medium may not include a credential (e.g., a card number, a payment account number, a security code, a card verification value, among other examples) associated with initiating exchanges with terminals printed on the surface of the payment medium. This may increase a difficulty associated with the physical medium being used to initiate card-not-present or online transactions (e.g., which may be associated with a higher likelihood of fraud). For example, not including information that can be used to initiate card-not-present or online transactions printed on the payment medium may ensure that these type of transactions (e.g., card-not-present or online transactions) are not associated with the account.

As shown in FIG. 1B, the user device may interact with the payment medium to initiate an exchange associated with contributing resources to the account associated with the payment medium. The user device may obtain routing information associated with the account. For example, as shown by reference number 115, the user device may scan (e.g., via a camera of the user device) an optical image, machine readable code, and/or QR code, among other examples, to obtain the routing information. For example, as described above, the optical image, machine readable code, and/or QR code may be associated with the identifier of the account and may be printed or displayed on a surface of the payment medium. As another example, the optical image, machine readable code, and/or QR code may be located in a different location (e.g., may not be printed or displayed on the surface of the payment medium).

Additionally, or alternatively, as shown by reference number 120, the payment medium may communicate with the user device to indicate the identifier and/or routing information associated with the account. For example, the payment medium may transmit (e.g., via the RF component, the IC component, a near-field communication (NFC) component, or another component) an indication of the identifier to initiate a first transaction associated with receiving resources to the account from another account associated with a user of the user device. For example, the payment medium may detect that the payment medium is within a communicative proximity of the user device. “Communicative proximity” may refer to a distance that enables the card to communicate with the user device or another device (e.g., the terminal). For example, the payment medium may detect, via an NFC component, a Bluetooth component, the IC chip component, or the RF component, that the payment medium is within the communicative proximity of the user device. Based on detecting that payment medium is within the communicative proximity of the user device, the payment medium may transmit, to the user device, the indication of the identifier and/or routing information associated with the account.

As another example, the identifier associated with the account may be input (e.g., by a user) to the user device. For example, the identifier may be printed on a surface of the payment medium. In the event that automated methods for providing the identifier to the user device fail, the user of the user device may read the identifier from the surface of the payment medium and manually input the identifier into the user device (e.g., into the payment application).

As described above, the identifier may provide routing information (e.g., an account identifier) associated with the account for one or more peer-to-peer exchange applications (e.g., and may not be associated with completing transactions with a vendor or merchant). As shown by reference number 125, the user device may obtain the routing information for contributing resources to the account based on scanning a machine readable image, such as a QR code (e.g., as shown by reference number 115) and/or based on communicating with the payment medium (e.g., as shown by reference number 120). For example, scanning the machine readable image and/or communicating with the payment medium may cause a payment application to automatically execute on the user device (e.g., the payment application may load or may cause a notification requesting for the payment application to launch to be displayed by the user device). Based on scanning the machine readable image, such as a QR code, and/or based on communicating with the payment medium, routing information associated with the account (e.g., an account identifier associated with the account and the payment application) may be automatically loaded or populated in the payment application. As described elsewhere herein, the payment application may be a peer-to-peer payment application, such as ZELLE, VENMO, CASH APP, PAYPAL, APPLE PAY, or GOOGLE PAY, among other examples. As another example, the payment application may be associated with, or provided by, an instruction that is associated with an account (e.g., a bank account or another financial account) of a user associated with the user device.

As shown by reference number 130, the user device may obtain or receive an indication of a contribution of resources to the account associated with the payment medium. For example, the user of the user device may interact with the payment application to indicate a quantity of resources to be contributed to, transferred to, and/or donated to the account associated with the payment medium. For example, as described above, based on scanning the machine readable image, such as a QR code, and/or based on communicating with the payment medium, routing information associated with the account (e.g., an account identifier associated with the account and the payment application) may be automatically loaded or populated in the payment application. As a result, the user may simply input an amount or quantity of resources to be contributed to the account via the payment application. This reduces time resources, processing resources, computing resources, and/or network resources that would have otherwise been used to navigate one or more user interfaces to locate the payment application, interact with the user device to launch the payment application, navigate to a page of the payment application associated with initiating a transaction, and/or input the routing information into the payment application, among other examples.

As shown by reference number 135, the user device may transmit information associated with an exchange to contribute resources to the account associated with the payment medium. The information may include an indication of an identifier of the account (e.g., based on the routing information), an identifier of an account associated with the user of the user device, and/or an indication of an amount or quantity of resources to be contributed to the account. In some implementations, the user device may transmit the information to the backend device (e.g., as shown in FIG. 1B). In some other examples, the user device may transmit the information to another device, such as a server device associated with the payment application. In such examples, the other device may transmit or forward the information to the backend device.

The backend device may receive (e.g., from the user device or another device) an indication of the exchange associated with contributing resources from another account (e.g., associated with the user of the user device) to the account (e.g., associated with the payment medium). For example, the backend device may receive an indication of the peer-to-peer exchange associated with contributing resources from the other account to the account associated with the payment medium. In some examples, the backend device may communicate with a peer-to-peer exchange application (e.g., with a payment application, such as with a server device associated with the payment application) to complete the exchange. Based on completing the exchange, resources from the account associated with the user of the user device may be made available to the account associated with the payment medium.

As shown by reference number 140, the backend device may configure the resources to be available for the account with one or more restrictions on a use of the resources (e.g., in accordance with the one or more restrictions). For example, the backend device may configure one or more parameters (e.g., restriction parameters) or otherwise check to make the resources available subject to the one or more restrictions. The one or more restrictions may be, or may be similar to, the restrictions described above in connection with FIG. 1A.

In some implementations, one or more restrictions may be associated with the particular resources contributed by the user associated with the user account. In such examples, the backend device may receive an indication of the one or more restrictions in addition to the information associated with the exchange (e.g., received by the backend device as described in connection with reference number 135). For example, the user may input the one or more restrictions to the user device when the user inputs the information associated with the exchange. The backend device may maintain a record or a log of the one or more restrictions. For example, the backend device may store an indication of the one or more restrictions in an entry of a data structure. The entry may be linked or mapped to the resources contributed from the account associated with the user of the user device. The backend device may store other restrictions associated with other resources contributed to the account in a similar manner. As a result, the backend device may be enabled to maintain different restrictions associated with different resources that are associated with the same account.

As shown in FIG. 1C, a user who is in possession of the payment medium may be enabled to access and/or view account information associated with the account. In some implementations, as shown by reference number 145, the payment medium may transmit, to the client device, an indication of the identifier associated with the account to cause the client device to display account information associated with the account. For example, the payment medium may communicate with the client device using the RF component, the IC chip component, the NFC component, or another component, to indicate the identifier associated with the account. As another example, the client device may scan (e.g., via a camera of the client device) the machine readable image, or another image printed on, displayed by, or associated with the payment medium to obtain the identifier associated with the account. For example, the client device may scan a QR code (e.g., the same QR code associated with providing the routing information or another QR code) to obtain the identifier associated with the account. The identifier associated with the account may be the same identifier described above (e.g., associated with providing the routing information) or may be a different identifier (e.g., associated with an institution that manages or provides the account). As another example, the identifier associated with the account may be input (e.g., by a user) to the client device.

As shown by reference number 150, the client device may transmit, and the backend device may receive, a request for account information associated with the account. The request may indicate the identifier associated with the account. For example, the backend device may receive, from the client device, an indication of the identifier associated with the account. The client device may transmit the request based on receiving a user input (e.g., to the client device) and/or based on obtaining the identifier associated with the account.

The backend device may receive the request and search for the account information using the identifier associated with the account. For example, the backend device may parse account information to identify the account information associated with the account (e.g., using the identifier). In some implementations, the backend device may determine whether the client device is authorized to receive the account information. For example, the account may be associated with an administrator account associated with managing the account. A user may input credentials (e.g., a username and password, or other example credentials) into the client device as part of initiating the request for the account information. If the credentials input to the client device match credentials stored by the backend device, then the backend device may determine that the client device is authorized to receive the account information.

As shown by reference number 155, the backend device may transmit, and the client device may receive, an indication of the account information. For example, the backend device may transmit, to the client device, display information to cause the account information associated with the account to be displayed by the client device. The account information may include a balance associated with the account, and/or the one or more restriction parameters (e.g., the one or more restrictions) associated with the account, among other examples.

As shown by reference number 160, the client device may display the account information. For example, as shown in FIG. 1C, the client device may display an indication of a balance associated with the account (e.g., $75.00). The balance may indicate an amount or quantity of available resources associated with the account. Additionally, as shown in FIG. 1C, the client device may display an indication of the restrictions on the use of the resources associated with the account. For example, the restrictions may include one or more permitted entities (e.g., Entity A, Merchant B, Vendor C, among other examples), one or more permitted items, (e.g., Food, Clothing, Non-alcoholic beverages, among other examples), and/or a geographic restriction (e.g., that transactions must occur within 25 miles of the zip code 12345), among other examples. In this way, a user who is in possession of the payment medium may avoid initiating transactions that will be declined due to the transaction amount exceeding the balance and/or based on the transaction not satisfying or complying with the one or more restrictions. This may conserve processing resources, computing resources, and/or network resources that would have otherwise been used initiating transactions that will be declined, transmitting information associated with transactions that will be declined, and/or determining whether to approve or deny the transaction(s), among other examples.

In some implementations, an identifier (e.g., a name and/or other identifying information) associated with the user who is currently in possession of the payment medium may be input to the client device. For example, as described above, the account of the payment medium may be associated with an administrator account or administrator credentials. A user may log in to the account using the administrator credentials to manage and/or edit information associated with the account. For example, the user may input the name associated with the user who is currently in possession of the payment medium. This may enable the payment medium to be returned to the correct user should the payment medium be lost or misplaced by the user. For example, the backend device may receive, from the client device, an indication of the identifier (e.g., the name and/or other identifying information) associated with a user that is in possession of the payment medium. The backend device may store the identifier associated with the user (e.g., in connection with the account information) to indicate that the user is temporarily associated with the account. Therefore, a subsequent request for the account information may result in the backend device transmitting an indication of the identifier associated with the user and an indication that the user was last in possession of the payment medium. This may enable the user and/or an administrator associated with the payment medium to identify the user currently in possession of, or who was last in possession of, the payment medium (e.g., as the payment medium is not permanently associated with any single individual).

In some implementations, a user may use the client device to identify account information or account identifiers associated with accounts that have contributed resources to the account of the payment medium (e.g., based on receiving a permission from users associated with the accounts). This may enable the user (e.g., who has received contributed resources as explained herein) to repay the contributed resources. For example, the user may identify a routing address, account identifier, or other information to enable the user to repay contributed resources after receiving the contributed resources.

As shown in FIG. 1D, the payment medium may be used to initiate and/or complete one or more transactions (e.g., associated with an entity, vendor, and/or merchant). For example, as shown by reference number 165, the payment medium may initiate a transaction with the terminal. In some implementations, the payment medium may detect, via the RF component, the NFC component, or the IC chip component, that the payment medium is within a communicative proximity of the terminal. Based on detecting that the payment medium is within the communicative proximity of the terminal, the payment medium may transmit, to the terminal, an account identifier (e.g., a card number, a payment credential, a payment account identifier, or another identifier) that can be used to initiate transactions. As another example, the terminal may obtain the account identifier via a magnetic stripe of the payment medium (e.g., the payment medium may be swiped via a card reader of the terminal). As another example, the terminal may obtain the account identifier via the IC chip component of the payment medium. The account identifier may be different than the identifier(s) described above associated with providing routing information associated with the account and/or with obtaining the account information.

As shown by reference number 170, the terminal may transmit, and the backend device may receive, a request for an approval of the exchange. For example, the backend device may receive, from the terminal, an indication of the exchange that is initiated by the physical medium that is to be at least partially completed using the resources of the account. The indication may include information associated with the exchange. The information associated with the exchange may include an amount associated with the exchange, an entity associated with the exchange, an indication of one or more items or services associated with the exchange, and/or a time of the exchange, a geographic location of the exchange, among other examples.

As shown by reference number 175, the backend device may determine whether to approve the exchange based on the one or more restrictions associated with the account. For example, the backend device may determine whether an identifier of the entity is indicated as being included in one or more permitted entities by the one or more restrictions. Additionally, or alternatively, the backend device may determine whether identifiers of the one or more items or services associated with the exchange are indicated as being included in one or more permitted items by the one or more restrictions. The backend device may determine whether to approve the second exchange based on whether the entity is included in the one or more permitted entities and/or whether the one or more items are included in the one or more permitted items, among other examples. The backend device may determine whether the exchange complies with, or satisfies, other restrictions associated with the account in a similar manner. For example, the backend device may determine whether a geographic location of the exchange is within a permitted area as indicated by a geographic restriction. Additionally, or alternatively, the backend device may determine whether the balance of the account is sufficient to complete the exchange (e.g., is equal to or greater than the amount associated with the exchange).

If the backend device determines that the information associated with the exchange complies with, or satisfies, the one or more restrictions associated with the account (e.g., and if the balance of the account is sufficient), then the backend device may determine that the exchange is approved. In some implementations, as shown by reference number 180, the backend device may determine resources, associated with the account, to be used to complete the exchange. For example, the backend device may determine the resources to be used to complete the exchange based on at least one of: an order in which the resources were contributed to the account, a temporal restriction associated with one or more subsets of the resources, and/or an entity restriction associated with the one or more subsets of the resources. For example, a subset of the resources may be associated with restriction(s) that were indicated by a user who contributed the resources, where the restriction(s) are associated with the subset, but may not be associated with other resources of the account (e.g., as described in more detail above). Therefore, the backend device may analyze the restrictions associated with the account and/or restrictions associated with subsets of resources to determine the resources to be used to complete the exchange.

For example, the backend device may first identify resources that are associated with restrictions that are satisfied, or complied with, by the information associated with the exchange. From those resources, the backend device may identify resources associated with a temporal or time restriction. If any of the resources are associated with a temporal or time restriction, then the backend device may select the resources that are associated with an expiration time (e.g., as indicating by the temporal restriction) that is closest to a current time (e.g., the backend device may select the resources that are close to expiring first). If none of the resources are associated with a temporal or time restriction, or if multiple sets of resources are associated with the same temporal or time restriction, then the backend device may determine the resources to be used to complete the exchange based on the order in which the resources were contributed to the account (e.g., resources that were contributed earlier in time may be used first).

As shown by reference number 185, the backend device may transmit, to the terminal, an indication of whether the exchange is approved based on the determination of whether the information associated with the second exchange complies with the one or more restrictions. As shown by reference number 190, the terminal may complete the exchange or deny the exchange based on the indication from the backend device. Therefore, as described above, the payment medium may communicate, via the RF component and with the terminal, to complete the exchange at least partially using the resources based on information associated with the second exchange satisfying the one or more restrictions (e.g., restriction parameters) associated with the account. This may ensure that no unauthorized transactions are completed using the contributed resources associated with the account. Moreover, this may reduce fraud associated with the account of the payment medium by ensuring that the resources associated with the account are used to complete transactions that are associated with an intended purpose or use (e.g., as indicated by the one or more restrictions).

As indicated above, FIGS. 1A-1D are provided as an example. Other examples may differ from what is described with regard to FIGS. 1A-1D.

FIG. 2 is a diagram of an example environment 200 in which systems, devices, and/or methods, described herein, may be implemented. As shown in FIG. 2, environment 200 may include a card 210, a terminal 220, a user device 230, a network 240, a backend device 250, a payment medium 260, and a client device 290. Devices of environment 200 may interconnect via wired connections, wireless connections, or a combination of wired and wireless connections.

Card 210 includes a transaction card capable of storing and/or communicating data for a point-of-sale (PoS) transaction with the terminal 220 and/or the payment medium 260. For example, the card 210 may store or communicate data including account information (e.g., an account identifier, a cardholder identifier, etc.), expiration information of the card 210, banking information, and/or transaction information (e.g., a payment token), among other examples. For example, to store or communicate the data, the card 210 may include a magnetic stripe and/or an IC chip (e.g., a EUROPAY®, MASTERCARD®, and VISA® (EMV) chip). In some implementations, the card 210 may include an antenna to communicate data associated with the card 210, and/or may be capable of communicating wirelessly (e.g., via Bluetooth, Bluetooth Low Energy (BLE), and/or NFC) with another device, such as the terminal 220, the payment medium 260, and/or a digital wallet, among other examples. In some implementations, the card 210 may communicate with the terminal 220 and/or the payment medium 260 to complete a transaction (e.g., based on being within communicative proximity of the terminal 220 and/or the payment medium 260).

The terminal 220 includes one or more devices to facilitate processing a transaction via the card 210 and/or the payment medium 260. The terminal 220 may include a PoS terminal, a security access terminal, and/or an ATM terminal, among other examples. The terminal 220 may include one or more input devices and/or output devices to facilitate obtaining transaction card data from the card 210 and/or the payment medium 260, and/or interaction or authorization from a cardholder of the card 210 and/or the payment medium 260. Example input devices of the terminal 220 may include a number keypad, a touchscreen, a magnetic stripe reader, a chip reader, an NFC component, and/or an RF signal reader, among other examples. Example output devices of the terminal 220 may include a display device, a speaker, and/or a printer, among other examples.

User device 230 includes one or more devices capable of receiving, generating, storing, processing, and/or providing information associated with the card 210 and/or the payment medium 260. For example, the user device 230 may include a communication device and/or a computing device, such as a mobile phone (e.g., a smart phone, a radiotelephone, etc.), a desktop computer, a laptop computer, a tablet computer, a handheld computer, a gaming device, a wearable communication device (e.g., a smart wristwatch, a pair of smart eyeglasses, etc.), or a similar type of device. In some implementations, the user device 230 may include application logic capable of facilitating communications between the terminal 220 and the payment medium 260.

Network 240 includes one or more wired and/or wireless networks. For example, network 240 may include a cellular network (e.g., a long-term evolution (LTE) network, a code division multiple access (CDMA) network, a 3G network, a 4G network, a 5G network, another type of next generation network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

Backend device 250 includes one or more devices associated with a bank and/or a transaction card association that authorizes transactions and/or facilitates a transfer of funds or payments between an account of a cardholder of the card 210 and/or the payment medium 260 and an account of an individual or business of the terminal 220. For example, backend device 250 may include one or more devices of one or more issuing banks associated with a cardholder of the card 210 and/or the payment medium 260, one or more devices of one or more acquiring banks (or merchant banks) associated with the terminal 220, and/or one or more devices associated with one or more card associations (e.g., VISA®, MASTERCARD®, and/or the like) associated with the card 210 and/or the payment medium 260.

The payment medium 260 includes a transaction card capable of storing and/or communicating data for a PoS transaction with the terminal 220, and capable of receiving and/or storing data for a PoS transaction with the card 210. In some implementations, the payment medium 260 may be referred to as a multi-function transaction card. For example, the payment medium 260 may store or communicate data including account information (e.g., an account identifier, a cardholder identifier, etc.), expiration information of the payment medium 260, banking information, and/or transaction information (e.g., a payment token), among other examples. For example, to store or communicate the data, the payment medium 260 may include a magnetic stripe and/or an IC chip (e.g., an EMV chip).

In some implementations, the payment medium 260 may include a card body in or on which various components are embedded. In some implementations, the payment medium 260 may include an antenna to communicate data associated with the terminal 220 and/or the card 210 and/or may be capable of communicating wirelessly (e.g., via Bluetooth, BLE, NFC, and/or another wireless communication protocol) with another device, such as the terminal 220, the card 210, the user device 230, and/or a digital wallet, among other examples. In some implementations, the payment medium 260 may communicate with the terminal 220, the card 210, and/or the user device 230, among other examples, to complete a transaction (e.g., based on being moved within communicative proximity of the terminal 220, the card 210, and/or the user device 230). In some implementations, the payment medium 260 may include one or more components and/or one or more functionalities of the terminal 220 and/or one or more components and/or functionalities of the card 210.

Power bus 262 includes a component that permits the delivery of power to various components of the payment medium 260. Bus 264 includes a component that permits communication among various components of the payment medium 260. RF/NFC 266 may include a communication link that permits data delivery between secure element 274, NFC antenna 276, and NFC front end 278.

Power source 268 includes one or more devices, internal to the payment medium 260, capable of supplying power. For example, power source 268 may include a battery (e.g., a rechargeable battery or a non-rechargeable battery), a power supply, and/or a capacitor (e.g., a supercapacitor and/or an ultracapacitor), among other examples.

Power management component 270 includes one or more devices capable of controlling the delivery of power to various components of the payment medium 260 and/or controlling charging of power source 268. For example, power management component 270 may include a switch, a gate, a controller, a regulator, a processing component, a bidirectional logic level shifter, and/or a diode, among other examples. In some implementations, power management component 270 may control signals between controller 272 and secure element 274 (e.g., to couple or decouple controller 272 and secure element 274, to prevent signals from being passed between controller 272 and secure element 274).

Controller 272 includes one or more devices capable of receiving, generating, storing, processing, and/or providing information and/or instructions that assist with performing a transaction. For example, controller 272 may include a processor, a memory, and/or the like, as described elsewhere herein. In some implementations, controller 272 may be directly, communicatively coupled to secure element 274 (e.g., via a dedicated, single-wire communication link).

Secure element 274 includes one or more devices capable of securely hosting an operating system and/or an application, and/or storing confidential information (e.g., a credential, cryptographic information). For example, secure element 274 may include a universal integrated circuit card (UICC), a secure digital (SD) card (e.g., a microSD card), and/or an embedded secure element, among other examples. In some implementations, secure element 274 may include one or more processors (e.g., one or more microcontrollers) certified by a standard body group, such as an EMV Consortium (EMVCo) certified (e.g., 16-bit or another size) secure microcontroller. In some implementations, secure element 274 may host a personalized card application and a cryptographic key required to perform a financial transaction (e.g., with the terminal 220).

In some implementations, secure element 274 may include application logic configured to communicate with NFC front end 278 (e.g., to cause NFC front end 278 to provide card data from secure element 274 to the terminal 220 to submit a payment, and/or to cause NFC front end 278 to receive card data from another transaction card (e.g., the card 210) to process a payment). In some implementations, secure element 274 may include application logic configured to communicate with controller 272 (e.g., to cause controller 272 to communicate with a user device (e.g., the user device 230) to facilitate online data authentication relating to a transaction (e.g., with the card 210), and/or to receive instructions from controller 272 to initiate transaction processing (e.g., associated with the card 210), among other examples). In some implementations, secure element 274 may include application logic configured to receive inputs from input device 280 (e.g., directly or via controller 272), and/or to provide outputs to output device 282 (e.g., directly or via controller 272), among other examples.

NFC antenna 276 includes an antenna capable of transmitting and/or receiving information using an NFC protocol. For example, NFC antenna 276 may include a loop antenna (e.g., an NFC loop antenna), and/or an inductor (e.g., an NFC inductor), among other examples. In some implementations, NFC antenna 276 may be integrated into, or with, secure element 274 and/or NFC front end 278 (e.g., may be part of the same integrated circuit, such as a transaction IC).

NFC front end 278 includes one or more devices capable of communicating with external devices, such as the card 210 and/or the terminal 220, using an NFC protocol. NFC front end 278 may include one or more radio modules for receiving and/or emitting NFC signals. NFC front end 278 may include one or more processors (e.g., microprocessor(s), microcontroller(s), and/or the like) and/or be coupled to one or more processors, such as controller 272, processor(s) included in secure element 274, and/or the like.

Although not shown, in some implementations, the payment medium 260 may include a transaction IC that includes an integrated circuit connecting secure element 274, NFC antenna 276, and/or one or more other components of the 260. For example, the transaction IC may include secure element 274, NFC antenna 276, NFC front end 278, connection(s) between secure element 274, NFC antenna 276, and/or NFC front end 278, among other examples.

Input device 280 includes one or more components that permit the payment medium 260 to receive information, such as via user input (e.g., to initiate a transaction, such as to receive card data from the card 210). For example, input device 280 may include an input component described elsewhere herein. Output device 282 includes one or more components that permit the payment medium 260 to provide output information (e.g., relating to transaction processing associated with the card 210 and/or the terminal 220). For example, output device 282 may include an output component described elsewhere herein. Communication device 284 includes a transceiver-like component that enables the payment medium 260 to communicate with other devices. For example, communication device 284 may include a communication component described elsewhere herein.

The client device 290 includes one or more devices capable of receiving, generating, storing, processing, and/or providing information associated with a physical medium (e.g., the payment medium 260) for restricted account access to contributed resources, as described elsewhere herein. The client device 290 may include a communication device and/or a computing device. For example, the client device 290 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to the card 210, the terminal 220, the user device 230, the backend device 250, the payment medium 260, and/or the client device 290. In some implementations, the card 210, the terminal 220, the user device 230, the backend device 250, the payment medium 260, and/or the client device 290 include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

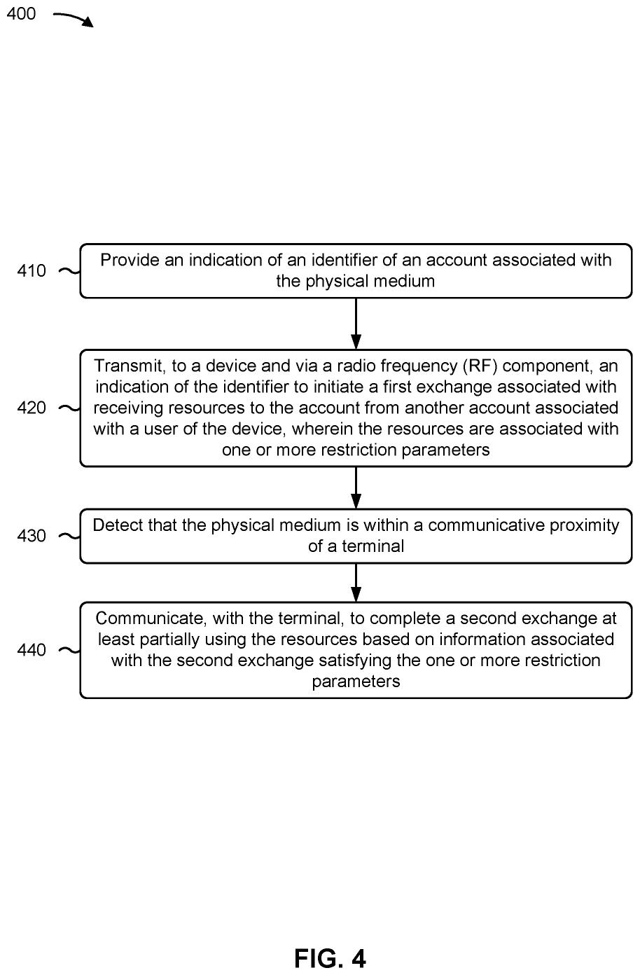

FIG. 4 is a flowchart of an example process 400 associated with physical medium for restricted account access. In some implementations, one or more process blocks of FIG. 4 may be performed by a physical medium (e.g., payment medium 260 or the card 210). In some implementations, one or more process blocks of FIG. 4 may be performed by another device or a group of devices separate from or including the physical medium, such as the terminal 220, the user device 230, the backend device 250, and/or the client device 290. Additionally, or alternatively, one or more process blocks of FIG. 4 may be performed by one or more components of device 300, such as processor 320, memory 330, input component 340, output component 350, and/or communication component 360.

As shown in FIG. 4, process 400 may include providing an indication of an identifier of an account associated with the physical medium (block 410). In some implementations, the indication of the identifier is provided via an RF component, an IC chip component, or an optical image displayed on a surface of the physical medium. For instance, the physical medium may be a credit card, such as card 210, and the indication may be a QR code displayed on the credit card, wherein the QR code is readable by a device, such as the user device 230.

As further shown in FIG. 4, process 400 may include transmitting, to a device and via the RF component, an indication of the identifier to initiate a first exchange associated with receiving resources to the account from another account associated with a user of the device (block 420). According to one example, the first exchange may be a transfer of funds or a payment from the user device 230 to the card 210. In some implementations, the resources are associated with one or more restriction parameters.

As further shown in FIG. 4, process 400 may include detecting, via the RF component or the IC chip component, that the physical medium is within a communicative proximity of a terminal (block 430). For example, the card 210 may be brought into communicative proximity of the terminal 220.

As further shown in FIG. 4, process 400 may include communicating, via the RF component and with the terminal, to complete a second exchange at least partially using the resources based on information associated with the second exchange satisfying the one or more restriction parameters (block 440). According to one example, the second exchange may be a purchase at a point-of-sale (PoS) transaction with the terminal 220 and/or the payment medium 260.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D.

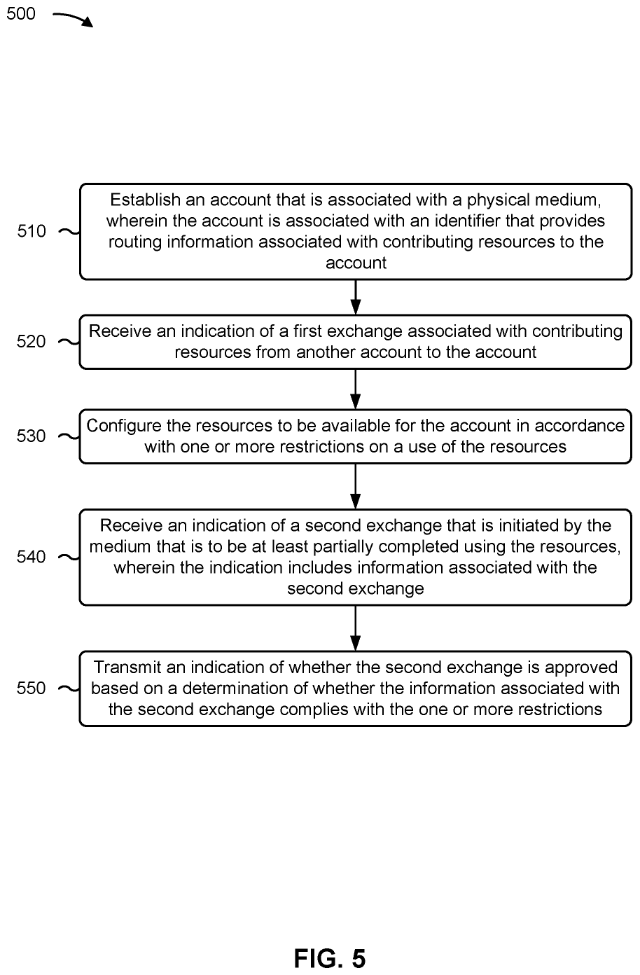

FIG. 5 is a flowchart of an example process 500 associated with physical medium for restricted account access. In some implementations, one or more process blocks of FIG. 5 may be performed by a backend device (e.g., backend device 250). In some implementations, one or more process blocks of FIG. 5 may be performed by another device or a group of devices separate from or including the backend device, such as the card 210, the terminal 220, the user device 230, the payment medium 260, and/or the client device 290. Additionally, or alternatively, one or more process blocks of FIG. 5 may be performed by one or more components of device 300, such as processor 320, memory 330, input component 340, output component 350, and/or communication component 360.

As shown in FIG. 5, process 500 may include establishing an account that is associated with a physical medium (block 510). In some implementations, the account is associated with an identifier that provides routing information associated with contributing resources to the account. As further shown in FIG. 5, process 500 may include receiving an indication of a first exchange associated with contributing resources from another account to the account (block 520). As further shown in FIG. 5, process 500 may include configuring the resources to be available for the account in accordance with one or more restrictions on a use of the resources (block 530). As further shown in FIG. 5, process 500 may include receiving an indication of a second exchange that is initiated by the physical medium that is to be at least partially completed using the resources (block 540). In some implementations, the indication includes information associated with the second exchange. As further shown in FIG. 5, process 500 may include transmitting an indication of whether the second exchange is approved based on a determination of whether the information associated with the second exchange complies with the one or more restrictions (block 550).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1D or 4.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A physical medium for restricted account access, comprising:
a radio frequency (RF) component;
an integrated circuit (IC) chip component;
a memory; and
one or more processors, coupled to the memory, configured to:
transmit, to a device and via the RF component, an indication of an identifier of an account, associated with the physical medium, to initiate a first exchange associated with receiving resources to the account from another account associated with a user of the device, wherein the resources are associated with one or more restriction parameters;
detect, via the RF component or the IC chip component, that the physical medium is within a communicative proximity of a terminal; and
communicate, via the RF component and with the terminal, to complete a second exchange at least partially using the resources based on information associated with the second exchange satisfying the one or more restriction parameters.

2. The physical medium of claim 1, wherein the indication of the identifier of the account is provided via the RF component, the IC chip component, or an optical image displayed on a surface of the physical medium.

3. The physical medium of claim 1, wherein the one or more processors are further configured to:
transmit, to another device, an indication of the identifier to cause the other device to display account information associated with the account, wherein the account information includes at least one of: a balance associated with the account, or the one or more restriction parameters.

4. The physical medium of claim 1, wherein the physical medium does not include a credential associated with initiating exchanges with terminals, including the terminal, printed on a surface of the physical medium.

5. The physical medium of claim 1, wherein the one or more restriction parameters include at least one of:
a permitted or restricted entity category restriction parameter,
a permitted or restricted entity parameter,
a permitted or restricted item parameter,
an exchange type parameter,
a time restriction parameter, or
a geographic restriction parameter.

6. The physical medium of claim 1, wherein the physical medium includes at least one of:
a card,
a user device, or
a wearable device.

7. A system for restricted account access to contributed resources, the system comprising:
one or more memories; and
one or more processors, coupled to the one or more memories, configured to:
generate an identifier associated with an account that is associated with a physical medium, wherein the account is not associated with any personally identifiable information of a particular user;
receive an indication of a first exchange associated with contributing resources from another account to the account;
configure the resources to be available for the account with one or more restrictions on a use of the resources;
receive an indication of a second exchange that is initiated by the physical medium that is to be at least partially completed using the resources, wherein the indication includes information associated with the second exchange; and
transmit an indication of whether the second exchange is approved based on a determination of whether the information associated with the second exchange complies with the one or more restrictions.

8. The system of claim 7, wherein the one or more processors are further configured to:
cause the physical medium to be manufactured with an indication of the identifier printed on a surface of the physical medium, wherein the indication includes at least one of a machine readable code, or one or more characters associated with the identifier.

9. The system of claim 7, wherein the one or more restrictions apply to all resources associated with the account.

10. The system of claim 7, wherein the first exchange is associated with a peer-to-peer exchange, and wherein the second exchange is associated with an entity.

11. The system of claim 7, wherein the identifier provides routing information associated with the account for one or more peer-to-peer exchange applications.

12. The system of claim 7, wherein the one or more processors are further configured to:
receive, from a device, an indication of an identifier associated with a user that is in possession of the physical medium; and
store the identifier associated with the user to indicate that the user is temporarily associated with the account.

13. The system of claim 7, wherein the one or more restrictions include at least one of:
one or more permitted or restricted entity categories,
one or more permitted or restricted entities,
one or more permitted or restricted items,
one or more permitted or restrict item categories,
one or more permitted or restricted exchange types,
a time restriction, or
a geographic restriction.

14. The system of claim 7, wherein the information associated with the second exchange includes an identifier of an entity associated with the second exchange and identifiers of one or more items associated with the second exchange, and wherein the one or more processors are further configured to:
determine whether the identifier of the entity is indicated as being included in one or more permitted entities by the one or more restrictions;
determine whether the identifiers of the one or more items are indicated as being included in one or more permitted items by the one or more restrictions; and
determine whether to approve the second exchange based on whether the entity is included in the one or more permitted entities and whether the one or more items are included in the one or more permitted items.

15. A method for providing a physical medium for restricted account access, comprising:
establishing, by a device, an account that is associated with the physical medium, wherein the account is associated with an identifier that provides routing information associated with contributing resources to the account;
receiving, by the device, an indication of a first exchange associated with contributing resources from another account to the account;
configuring, by the device, the resources to be available for the account in accordance with one or more restrictions on a use of the resources;
receiving, by the device, an indication of a second exchange that is initiated by the physical medium that is to be at least partially completed using the resources, wherein the indication includes information associated with the second exchange; and
transmitting, by the device, an indication of whether the second exchange is approved based on a determination of whether the information associated with the second exchange complies with the one or more restrictions.

16. The method of claim 15, wherein the one or more restrictions include a first one or more restrictions associated with all resources associated with the account and a second one or more restrictions associated with the resources contributed from the other account, and wherein receiving indication of the first exchange comprises:
receiving an indication of the second one or more restrictions.

17. The method of claim 15, further comprising:
receiving, from a client device, an indication of the identifier associated with the account; and
transmitting, to the client device, display information to cause account information associated with the account to be displayed by the client device, wherein the account information includes at least one of a balance associated with the account or the one or more restrictions.

18. The method of claim 15, further comprising:
determining the resources to be used to complete the second exchange based on at least one of:
an order in which the resources were contributed to the account,
a temporal restriction associated with one or more subsets of the resources, or an entity restriction associated with the one or more subsets of the resources.

19. The method of claim 15, wherein the one or more restrictions indicate that the physical medium is to be used to complete exchanges that comply with parameters associated with an assistance program that is defined by a regulatory agency.

20. The method of claim 15, wherein receiving the indication of the first exchange comprises:
communicating with a peer-to-peer exchange application to complete the first exchange.
